(19) United States
(12) Patent Application Publication
(10) Pub. No.: US 2008/0168952 A1
(43) Pub. Date: Jul. 17, 2008

(54) APPARATUS AND ASSOCIATED METHOD FOR ILLUMINATING A COLLAR

(76) Inventor: SONDRA MOREHEAD, AMARILLO, TX (US)

Correspondence Address: SCHEEF & STONE, L.L.P., 5956 SHERRY LANE, SUITE 1400, DALLAS, TX, 75225, US

(21) Appl. No.: 11/692,653

(22) Filed: Mar. 28, 2007

Related U.S. Application Data
(63) Continuation-in-part of application No. 11/564,202, filed on Nov. 28, 2006.
Application No. 11/564,202 is a continuation of application No. 10/815,601, filed on Apr. 1, 2004, now Pat. No. 7,140,327.

(51) Int. Cl. A01K 27/00

(52) U.S. Cl. 119/859

(57) ABSTRACT

A collar to which is mounted an illumination source. Each of one or more light-transferring fibers includes a first end coupled for receiving light from the illumination source, and a second end coupled for transmitting light from the collar.

### CROSS-REFERENCE TO RELATED APPLICATIONS

This application is a continuation-in-part of U.S. patent Ser. No. 11/564,202, filed on Nov. 28, 2006, which is a continuation of U.S. Pat. No. 7,140,327, formerly patent application Ser. No. 10/815,601, filed Apr. 1, 2004, and issued on Nov. 28, 2006.

### TECHNICAL FIELD

The invention relates generally to collars and, more particularly, to safety collars for pets. Still more particularly, the invention relates to an apparatus and an associated method for illuminating a safety collar for use on pets.

### BACKGROUND

It is often difficult to see domestic or household animals, referred to herein as “pets,” at night or in a dimly lit or unlit area. For that reason, pets frequently pose a safety hazard, not only to themselves, but also to people who occupy the same space. For example, people may trip over pets during the night or in a dark room, resulting in potential harm to the person or to the pet, particularly if the person or pet is elderly or recovering from a medical procedure. An elderly person, furthermore, may not be as agile as a younger person, and may be sensitive to an unexpected impact with a pet, and could potentially suffer from an inadvertent or adverse contact with a pet. Likewise, any person with reduced night vision is at a potentially serious health and safety risk from tripping over a pet.

One solution to the foregoing hazards is to provide additional ambient light in unlit or dimly lit areas. However, people have varying sensitivities to light at night, and it is frequently desirable or necessary to maintain minimal, or no, ambient light at night.

Another solution that has been attempted has been to provide pet collars with light-reflecting strips or elements. However, there is often insufficient light to reflect off of such reflective strips or elements, thereby rendering such strips or elements of little or no effect.

To overcome the problem of a lack of light to reflect off of reflective elements of a collar, some collars have been equipped with fluorescent elements which glow temporarily after being exposed to an external light. However, the radiant glow fades quickly and generally does not last through the night, losing virtually all effect, rendering such solution unreliable.

A band of light may be provided on a collar, but that poses a problem to a pet because light may shine such that the animal's eyes are adversely affected, thus impeding that animal's sensory abilities. Additionally, the lights may constitute a distraction and a source of annoyance and discomfort to the pet and people.

Collars may be provided with noise-generating collar elements, such as a bell or chain. The noise generated from such collars may disturb both the animal and person as the pet moves about the house. Additionally, many people may not find noise or sound an adequate indicator of the animal's precise location or direction of motion.

It is apparent that conventional techniques do not satisfactorily address the aforementioned hazards and shortcomings with attempted solutions to the hazards. Therefore, what is needed is a pet safety collar which does not constitute a burden, and is thereby comfortable to a pet wearing the collar, while providing at the same time a clear, visible warning effective for enabling a person to identify a specific location of a pet, and to thereby assist in avoiding unwanted contact with such a pet in an unlighted environment.

### SUMMARY

The present invention, accordingly, provides a collar to which is mounted an illumination source and one or more optical fibers for transferring the light from the illumination source to different points across the collar.

In alternate embodiments of the invention, additional aspects of the invention include means for locating a pet, training a pet, and keeping a pet within predefined boundaries.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view exemplifying a safety collar embodying features of the present invention and positioned on a pet depicted in outline form;

FIG. 2 is a perspective view of the safety collar of FIG. 1 shown unclasped and removed from the pet;

FIG. 3 is an exploded view of the collar of FIG. 1;

FIG. 4 is a plan view of the collar of FIG. 1;

FIG. 5 is a cross-sectional view of the collar of FIG. 1 taken along the line 5-5 of FIG. 4;

FIG. 6 exemplifies an alternate view of the collar of FIG. 5 depicted in an open state;

FIG. 7 is cross-sectional view of the collar of FIG. 1 taken along the line 7-7 of FIG. 4;

FIG. 8 is a cross-sectional view of an alternate embodiment of the collar of FIG. 1 taken along the line 5-5 of FIG. 4;

FIG. 9 is a cross-sectional view of a second alternate embodiment of the collar of FIG. 1 taken along the line 5-5 of FIG. 4;

FIG. 10 exemplifies an illumination module utilized by the collar of FIG. 1;

FIG. 11 exemplifies an alternate embodiment of the illumination light source module of FIG. 11, including additional functionality;

FIG. 11A is a plan view exemplifying the collar of FIGS. 1-4 with an external power supply;

FIG. 11B is a cross-section of the collar of FIG. 11A taken along the line 11B-11B of FIG. 11A;

FIG. 11C is a schematic view exemplifying a portion of the power supply and related functionality of the collar of FIGS. 11A-11B;

FIG. 12 is a plan view exemplifying an alternative embodiment of a safety collar embodying features of the present invention;

FIG. 13 is a cross-sectional elevation view of the collar of FIG. 12 taken along the line 13-13 of FIG. 12;

FIG. 14A is a cross-sectional view of the collar of FIG. 12 taken along the line 14A-14A of FIG. 12;

FIG. 14B is a cross-sectional view of the collar of FIG. 12 taken along the line 14B-14B of FIG. 12;

FIG. 15 is a plan view exemplifying an alternative embodiment of the safety collar of FIG. 12;

FIG. 15A is a cross-sectional elevation view of the collar of FIG. 15 taken along the line 15A-15A of FIG. 15;

FIG. 16 is a plan view exemplifying a further alternate embodiment of a safety collar embodying features of the collars of FIGS. 12-15;

FIG. 17 is an elevation view of the collar of FIG. 16 taken along the line 17-17 of FIG. 16;

FIG. 18 is a cross-sectional view of the collar of FIG. 16 taken along the line 18-18 of FIG. 17;

FIG. 19 is a cross-sectional view of the collar of FIG. 16 taken along the line 19-19 of FIG. 17;

FIG. 20 is a cross-sectional view of the collar of FIG. 16 taken along the line 20-20 of FIG. 17;

FIG. 21 is a plan view exemplifying an alternate embodiment of the safety collar of FIG. 16;

FIG. 22 is a plan view exemplifying a further alternate embodiment of safety collar of FIG. 16, incorporating a lace design;

FIG. 23 exemplifies a cross-section of an alternate embodiment of the invention in which optical fibers are positioned on a plastic layer within a tube fabricated from a material such as nylon;

FIG. 24 exemplifies a cross-section of an alternate embodiment of the invention in which optical fibers are positioned directly on a single layer of material such as nylon;

FIG. 25 is a plan view exemplifying a double-collar embodying features of an alternate embodiment of the present invention;

FIG. 26 depicts a cross-section of the collar of FIG. 25 taken along the line 26-26 of FIG. 25;

FIG. 27 is a plan view exemplifying a double-illuminated-collar incorporating an illuminated portion interposed between the two collars in accordance with an alternate embodiment of the present invention;

FIG. 28 depicts a cross-section of the collar of FIG. 27 taken along the line 28-28 of FIG. 27;

FIG. 29 is a plan view exemplifying a double-collar incorporating an illuminated portion interposed between the two collars in accordance with an alternate embodiment of the present invention;

FIG. 30 depicts a cross-section of the collar of FIG. 31 taken along the line 30-30 of FIG. 29;

FIG. 31 is a plan view exemplifying a single double buckle collar embodying features of the present invention; and

FIG. 32 is a plan view exemplifying a dual double buckle collar embodying features of the present invention.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning fiber optics (also known as optical fibers) and the like have been omitted inasmuch as such details are not considered necessary to obtain a complete understanding of the present invention, and are considered to be within the skills of persons of ordinary skill in the relevant art.

It is noted that, where suitable, functions described herein may be performed by, or in conjunction with, a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

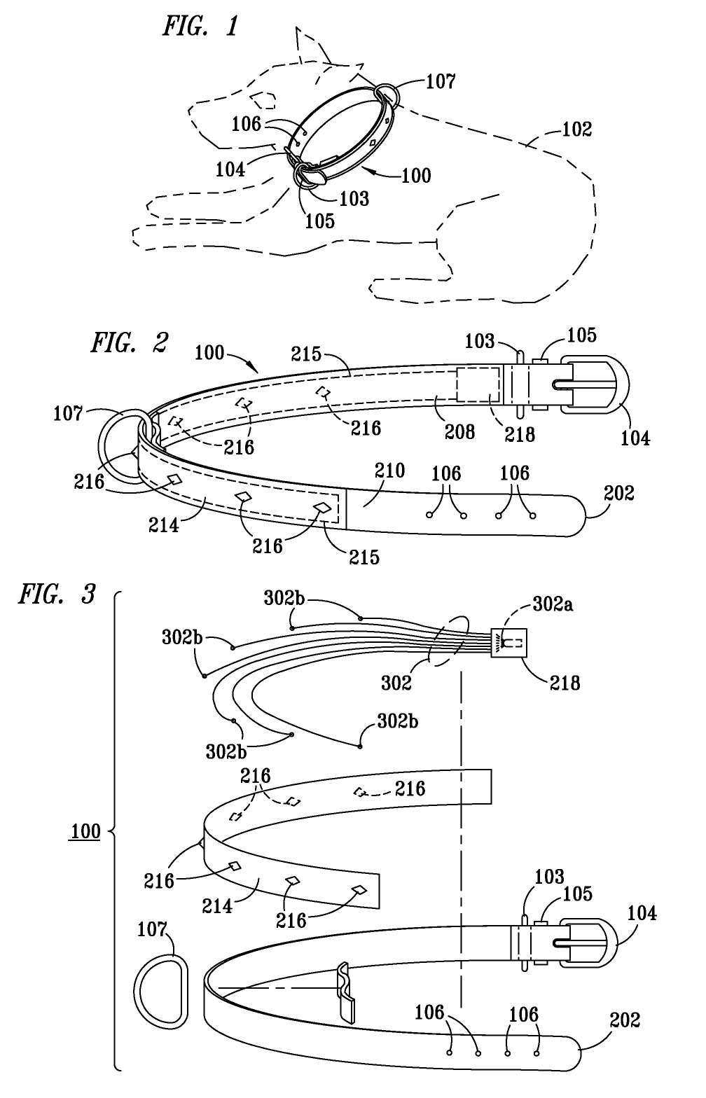

Referring to FIG. 1 of the drawings, the reference numeral 100 generally designates a safety collar embodying features of the present invention. The collar 100 is shown in a generally annular configuration fitted around the neck of a pet 102, such as a dog, cat, or the like, shown in outline form. The collar 100 is secured about the neck by any conventional clasp 104, exemplified in FIG. 1 as a buckle configured for matingly engaging holes 106 defined in the collar, and secured by collar buckle strap 105. A license and/or tag attachment ring 103 is secured on the collar 100 proximate to the clasp 104, and a leash attachment ring 107 is secured on the collar at a point preferably opposing the clasp 104 so that the leash attachment ring will be generally positioned at an uppermost portion of the collar when the clasp is at a lowermost point on the pet 102, thereby rendering the leash attachment loop 107 most accessible for connection to a leash (not shown) for walking or otherwise restraining a pet.

FIG. 2 shows the collar 100 apart from the pet 102, and the clasp 104 disengaged from the holes 106. As shown therein, the collar 100 comprises a collar base 202. The collar base 202 may be fabricated from any of a number of suitable materials, such as nylon, leather, cloth, metal, or the like, and any combination thereof, effective for remaining secured about the neck of the pet 102 and withstanding rough daily wear by a pet. The collar base 202 further comprises an interior surface 208 which would be positioned against the skin or fur of the pet 102 when fitted thereon, and an exterior surface 210 opposite the interior surface 208, which exterior surface is exposed and most easily visible to an observer when the collar is fitted on a pet.

A band 214 is positioned on the exterior surface 210 of the collar 100, and is preferably secured thereto via conventional stitching (e.g., stitching 215), adhesive, staples, rivets, snaps, and/or the like. A number of light-passing elements, referred to herein as insets, 216 (seven of which are depicted) are mounted on the band 214. The insets 216 may comprise any of a number of different materials, such as glass, plastic, hard plastic simulating precious stones (e.g., cubic zirconium), or the like, effective for permitting light to pass therethrough, and preferably resistant to heat and scratches. The insets 216, furthermore, may be configured in any desirable shape, such as a diamond shape (as exemplified in FIG. 2), a round shape, or an oval shape, and may be colored as desired. Still further, the insets 216 may optionally be detachably mounted on the band 214, thereby permitting removal of the insets and/or replacement of the insets by other insets, such as may be suitable and/or desirable for selected occasions. An illumination source 218, described in further detail below, is preferably mounted on the exterior surface 210 of the collar 100, and is secured therein by the band 214, as described in further detail below. Alternatively, the illumination source 218 may be mounted on the exterior surface 210 without cover of the band 214 to provide ready access to a person, or may be mounted on the interior surface 208 of the collar 100.

In a preferred embodiment, the insets 216 are positioned on the band 214 so as to be directed away from the pet's face and eyes. It is therefore contemplated that the insets 216 are positioned on the collar base 202 away from the head of the pet and toward its torso. Many household pets are sensitive to light, as are many people; thus, having a constantly glowing element on the animal's neck may constitute a nuisance to the pet.

As shown in FIG. 3, an exploded view of the collar 100, one or more light-transferring optical fibers, referred to herein as fiber optic strings, 302 extend from the illumination source 218. The light-transferring fiber optic strings 302 preferably comprise one or more (exemplified as seven in FIG. 2), fiber optic filaments fabricated utilizing conventional fiber optic technology, preferably generate little or virtually no heat, and are preferably sufficiently flexible to permit wrapping with the collar 100 around the neck of a pet. If multiple fiber optic filaments are utilized to constitute each of the fiber optic strings 302, the filaments may be encased in a sheath, fabricated from a material such as nylon. In alternative embodiments of the invention, the fiber optic strings 302 may be fabricated from any material, such as plastic, glass, and the like, effective for transferring light from a light source.

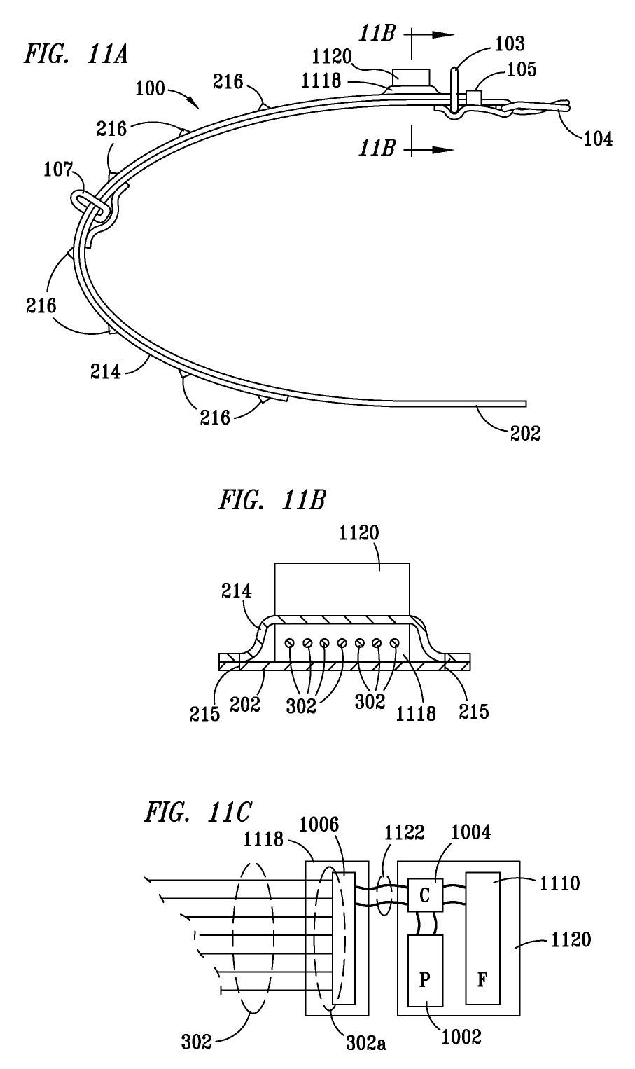

In a preferred embodiment, the number of fiber optic strings 302 corresponds to the number of insets 216, such that one fiber optic string 302 corresponds to a respective inset 216. Each fiber optic string 302 includes a first end 302a and a second end 302b. As described in further detail below with respect to FIGS. 10 and 11, the first end 302a is optically connected to the illumination source 218 for receiving light therefrom. The second end 302b of each fiber optic string 302 is secured to a respective inset 216 so that light received at the first end 302a is transferred through the end 302b and emitted through the insets 216 on the band 214. The length of each fiber optic string 302 between the first and second ends is preferably interposed between the collar base 202 and the band 214, and preferably secured thereto using an adhesive, such as glue or epoxy.

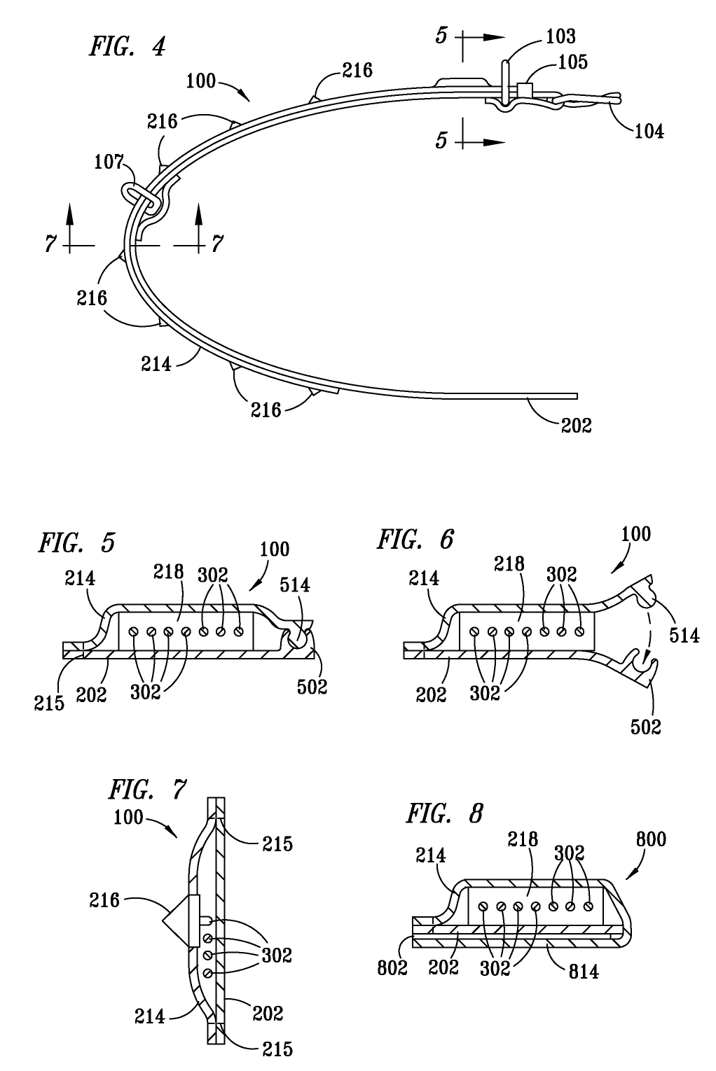

FIG. 4 shows a plan view of the collar 100 for the purpose of depicting selected sections of the collar shown in greater detail in FIGS. 5-7 below.

FIG. 5 shows a cross-section of the collar 100 taken along the line 5-5 of FIG. 4. As shown therein, the band 214 wraps around and encases the illumination source 218, depicted having seven fiber optic strings 302 extending therefrom. As viewed in FIG. 5, a seal 514 is formed along an upper edge of the band 214 for matingly engaging a cooperating seal 502 formed along an upper edge of the collar base 202, to thereby form a preferably water-tight seal in the manner of a Ziploc® seal. FIG. 6 shows the cross-section of FIG. 5, but with the seals 502 and 514 disengaged from each other to form an opening through which the illumination source 218 may be accessed, as described in further detail below.

FIG. 7 shows a cross-section of the collar 100 taken along the line 7-7 of FIG. 4. As viewed therein, the band 214 is secured to the collar base 202 via stitching (e.g., stitching 215), adhesive, staples, rivets, snaps, and/or the like, at both the top and bottom of the band, to thereby envelope fiber optic strings 302 traversing therethrough. It is noted that a selected one of the fiber optic strings 302 is coupled to the inset 216 for transferring light to the inset.

FIG. 8 shows a cross-section of an alternate embodiment of the collar 100, designated by the reference numeral 800, taken along the line 5-5 of FIG. 4. The collar 800 is similar to the collar 100, but for the seal portions 502 and 514, which are functionally replaced by an extended portion, or flap, 814 of the band 214 configured for wrapping around the collar base 202. The band flap 814 and collar base 202 are preferably provided with hook-and-loop material 802 such as Velcro® so that the band flap 814 and collar base 202 may be secured together. It may be appreciated that, with the collar 800 positioned on the neck of a pet, pressure of the collar against the neck of the pet will act to maintain the coupling of the hook-and-loop portions 802 of the Velcro®.

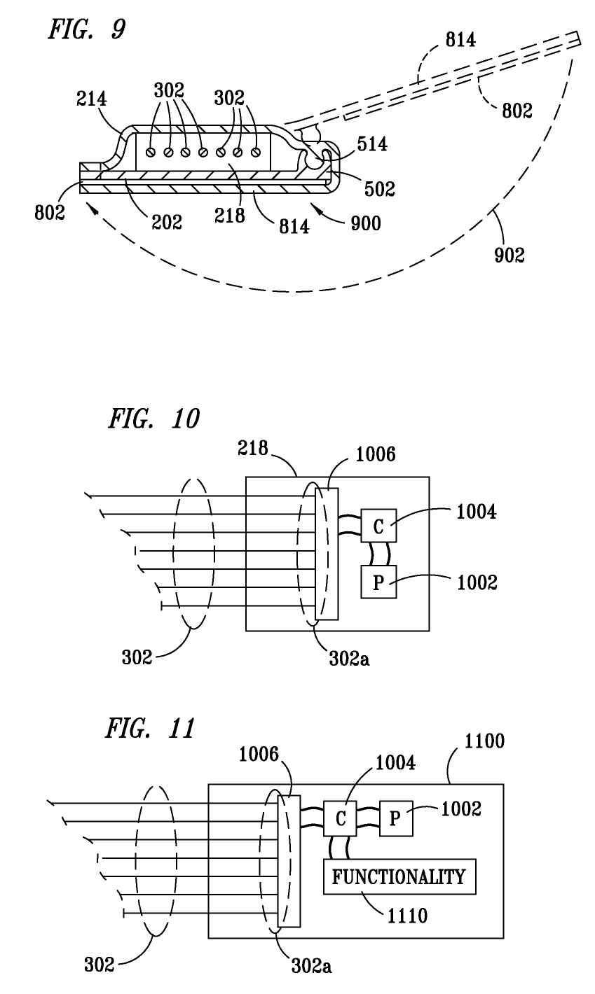

FIG. 9 shows a cross-section of a second alternate embodiment of the collar 100, designated by the reference numeral 900, taken along the line 5-5 of FIG. 4. The collar 900 is similar to the collar 100, but includes the seal portions 502 and 514 (FIG. 5), as well as the band flap 814 (FIG. 8) securable to the collar base 202 via hook-and-loop material 802 such as Velcro®. The schematic arrow 902 depicts closure of the flap 814 to the collar base 202, as discussed in further detail below.

FIG. 10 depicts the illumination source 218 having a light-generating element 1006 operably interconnected via a control mechanism 1004 to an electrical power supply 1002, such as a battery. The control mechanism 1004 preferably comprises a switch, such as a conventional mechanical switch, operable by a user for activating and de-activating the illumination source 218. The light-generating element 1006 preferably comprises one or more light emitting diodes (LED's) of one or more colors, but may alternatively comprise a conventional light bulb, or the like, preferably effective for generating a relatively low-intensity light having little or virtually no heat. The light emitted from the light-generating element 1006 is preferably visible to a human eye, but not to the eyes of the animal wearing the collar 100, it being understood that, while different pets may have different ranges of light to which they are not sensitive, some species may not be amenable to such a range. The ends 302a of the one or more fiber optic strings 302 are coupled to the light-generating element 1006 for receiving light therefrom. The power supply 1002 is preferably a replaceable battery, as is commonly employed in small electronic devices such as a watch, hearing aids, cameras, and the like, though may alternately comprise an alternate power source, such as solar power or a small generator effective for generating electrical energy from movement imposed by activity of the pet 102, which electrical energy may be stored for less active times in any conventional manner, such as by way of a capacitor or re-chargeable battery. The power supply 1002 may be re-positioned in the illumination source 218 adjacent the control mechanism 1004 to facilitate access and replacement. It is considered that additional circuitry and circuit elements (e.g., resistors, a transformer, semi-conductors, a microprocessor, and/or the like) may be coupled to the power supply 1002 and illumination source 218 as desired to facilitate functionality of the illumination source 218 described herein, and that such would be apparent to a person having ordinary skill in the art upon a reading of the present disclosure and, therefore, will not be described in further detail herein. The illumination source 218 is preferably housed in an enclosure that is configured (e.g., by sealing the entry points of the fiber optic strings 302 with a glue, such as epoxy) for preventing water from entering the enclosure and affecting the components housed therein. The illumination source 218 is furthermore, preferably enveloped in electrical and thermal insulation effective for protecting a pet from heat and energy that may emanate from the illumination source 218.

In an alternate embodiment of the illumination source 218, the control mechanism 1004 is wireless, configured, for example, as a radio frequency (RF) or infra red (IR) receiver effective for receiving from a remote control transmitter (not shown) RF or IR signals transmitted for activating and deactivating the illumination source 218. RF and IR remote control technology is considered to be well-known in the art and, therefore, will not be described in further detail herein. It may be appreciated that such application of wireless remote control technology permits a person to activate the illumination source 218 remotely without the necessity of capturing the pet prior to activating the illumination source 218. Alternatively, the control mechanism 1004 may comprise light sensing means, and be configured to activate the illumination source 218 when the light sensing means determines that ambient light is less than a predetermined threshold amount of light. In a still further alternate embodiment, the control mechanism 1004 may comprise motion sensing means, and be configured to activate the illumination source 218 when the motion sensing means determines that motion proximate to the pet (e.g., a person walking in the dark who could potentially trip over the pet) is greater than a predetermined threshold amount of motion. Still further, the illumination source 218 may be fabricated without any control mechanism, and be operable whenever connected to the power supply 1002, while the power supply has power to supply.

In operation, the collar 100 is positioned on a pet in a conventional manner. In the embodiment of FIGS. 5 and 10, the illumination source 218 is activated by separating the seal portions 502 and 514, accessing and operating the control mechanism 1004, and then closing the seal portions 502 and 514. In the embodiment of FIGS. 8 and 10, the illumination source 218 is activated by unwrapping the band flap 814, accessing and operating the control mechanism 1004, and then wrapping the band flap 814 back into a closed position. In the embodiment of FIGS. 9 and 10, the illumination source 218 is activated by unwrapping the band flap 814 and separating the seal portions 502 and 514, accessing and operating the control mechanism 1004, and then closing the seal portions 502 and 514 and wrapping the band flap 814 back into a closed position, as indicated schematically by the arrow 902. In the alternate embodiment of FIG. 5, 8, or 9, wherein the control mechanism 1004 comprises wireless technology (e.g., IR or RF), the illumination source 218 is activated by a remote control unit (not shown). Once the illumination source 218 is activated, then light is emitted from the light-generating element 1006 to the ends 302a of the one or more fiber optic strings 302. The fiber optic strings 302 carry the light from the light-generating element 1006 to the insets 216, and the light is then emitted through and from the insets 216 for alerting persons in poorly lit or unlit areas of the location of the pet wearing the collar 100, thereby preventing accidents, such as tripping over the pet.

The illumination source 218 remains in an activated state until the power supply 1002 is exhausted of power, or until a person deactivates the illumination source 218 in a manner analogous to the aforementioned steps employed to activate the illumination source 218. If the power supply 1002 is exhausted, then it may be replaced by accessing the power supply 1002, in a manner analogous to the aforementioned steps employed to activate the illumination source 218, and then replacing the battery in a conventional manner.

FIG. 11 depicts an alternate embodiment of the illumination source 218 (FIG. 10), designated by the reference numeral 1100, which has been enhanced with functionality 1110 that draws from the power supply 1002 via the control mechanism 1004. The functionality 1110 preferably includes circuitry and circuit elements (e.g., resistors, a transformer, semi-conductors, a microprocessor, and/or the like) suitably coupled thereto to facilitate functionality of any of one or more electronic features. For example, in one embodiment, the functionality 1110 includes a Radio Frequency Identification (RFID) transponder, or tag, integrated into the illumination source 1100. According to such embodiment, the functionality 1110 preferably comprises an active RFID tag coupled to the power supply 1002 for receiving power. The RFID tag is preferably configured for engaging, via a radio communication link, an RFID transceiver, not shown. RFID technology is considered to be well-known in the art, it therefore will not be discussed in further detail herein, except insofar as necessary to describe the invention. In operation, if a pet needs to be located or identified, and is wearing a collar with an illumination source 1100 enhanced with functionality 1110 comprising an RFID tag, a person may utilize an RFID transceiver in a conventional manner to locate or identify the pet.

In a further embodiment, the functionality 1110 of the illumination source 1100 comprises a global positioning system (GPS) device. The GPS device is preferably coupled to the power supply 1002 for receiving power, and is effective for determining location using technologies such as trilateration. The GPS device further comprises a transmitter (not shown) for transmitting, via a radio communication link, a signal indicative of a pet's location to a receiver or transceiver (not shown) monitored by the pet's owner (not shown). GPS and related technologies, such as GPS transmitters and receivers, are considered to be well-known, and therefore will not be discussed in further detail, except insofar as necessary to describe the present invention. In operation, if a pet with a collar and illumination source 1100 is lost, a person may utilize the GPS transceiver to determine the location, in a conventional manner, of the pet. In operation, if a pet is lost, but is wearing a collar with an illumination source 1100 enhanced with functionality 1110, such as GPS, a person may utilize a GPS transceiver in a conventional manner to locate the pet.

In a still further embodiment, the functionality 1110 of the illumination source 1100 may include electronic pet containment technology, effective for generating an electronic shock to a pet via electrodes (not shown) in contact with the pet. The electronic shock may be applied under any of a number of different circumstances, such as when the pet wanders more than a predetermined distance away from a radio transmitter, to thereby keep a pet within the predetermined distance from the transmitter so that it does not get lost. Alternatively, the electronic shock may be applied when a pet wanders across wires (e.g., buried in the ground) that run along a perimeter defining the boundaries within which a pet should be retained. Still further, such shocks may be applied remotely by a pet owner to train the pet, or, if the pet is a dog, a sensor may be provided that senses when the dog barks, and a shock applied to discourage the dog from barking. It is considered that such functionality, apart from the illumination features of the invention, and the operation thereof, are well-known, and therefore will not be described in further detail herein.

It is understood that the illumination sources 1100 may be substituted for the illumination source 218 in any of the embodiments of the invention described below. Still further, it is considered that the aforementioned additional features provided by the functionality 1110 may be combined in any manner desired, though every such combination is not explicitly disclosed here.

FIGS. 11A-11C exemplify one alternate embodiment of the invention in which an electrical power supply for the illumination source is provided in a module positioned externally of the collar. As shown in FIG. 11A, such a module 1120 is mounted atop the collar 100, proximate to an illumination source 1118. FIG. 11B depicts a cross-section of the power supply module 1120 atop the illumination source 1118, taken along the line 11B-11B of the collar. As shown schematically in FIG. 11C, the illumination source 1118 includes the light-generating element 1006 to which the ends 302a of fiber optic strings 302 are coupled, as described above with respect to FIG. 10.

The module 1120 preferably includes the power supply 1002 coupled to the control mechanism 1004 (e.g., mechanical or wireless switch), which in turn is coupled to the light-generating element 1006 via electrical conductors 1122 and, optionally, to the functionality 1110 as described above with respect to FIG. 11. The electrical conductors 1122 preferably comprise a plug configured for matingly engaging, preferably in a weatherproof manner, a corresponding receptacle in the module 1120 for conducting electrical current to the light-generating element 1006. Alternatively, the electrical conductors 1122 may comprise wires, electromagnetic fields, or the like, effective for transmitting electrical current, and the control mechanism 1004 may be located in the illumination source 1118. The module 1120, and optionally the illumination source 1118 as well, is/are secured, preferably detachably secured, to the collar 100 in any of a number of different manners, such as, by way of Velcro®, mechanical latches or fasteners (e.g., screws), a nylon or leather pouch or flap, or the like, or a combination thereof. The power source of the power supply 1002 may be perpetual, such as a generator mechanism that generates electricity from movement of the pet, or the power source may be configured for being periodically replenished, such as by way of one or more re-chargeable or replaceable batteries. If the batteries are re-chargeable, this may be accomplished in any of a number of different ways. For example, the module 1120 may be provided with plugs that not only plug into the illumination source, but also plug into a battery re-charger (not shown). If the batteries are replaceable, then the module 1120 may be provided with means (e.g., a lid, not shown) for accessing the battery for replacement.

In operation, the module 1120 is plugged into, or otherwise electrically coupled to the illumination source 1118, and secured to the collar 100, e.g., by way of mechanical latches, fasteners, Velcro®, or the like. The module 1120 may be detached for replacing or re-charging batteries, as discussed above, or to replace the module 1120 with another module with fresh batteries, and/or with different functionality 1110. Operation of the module 1120 and collar 100 is otherwise similar to that described above with respect to FIGS. 1-10.

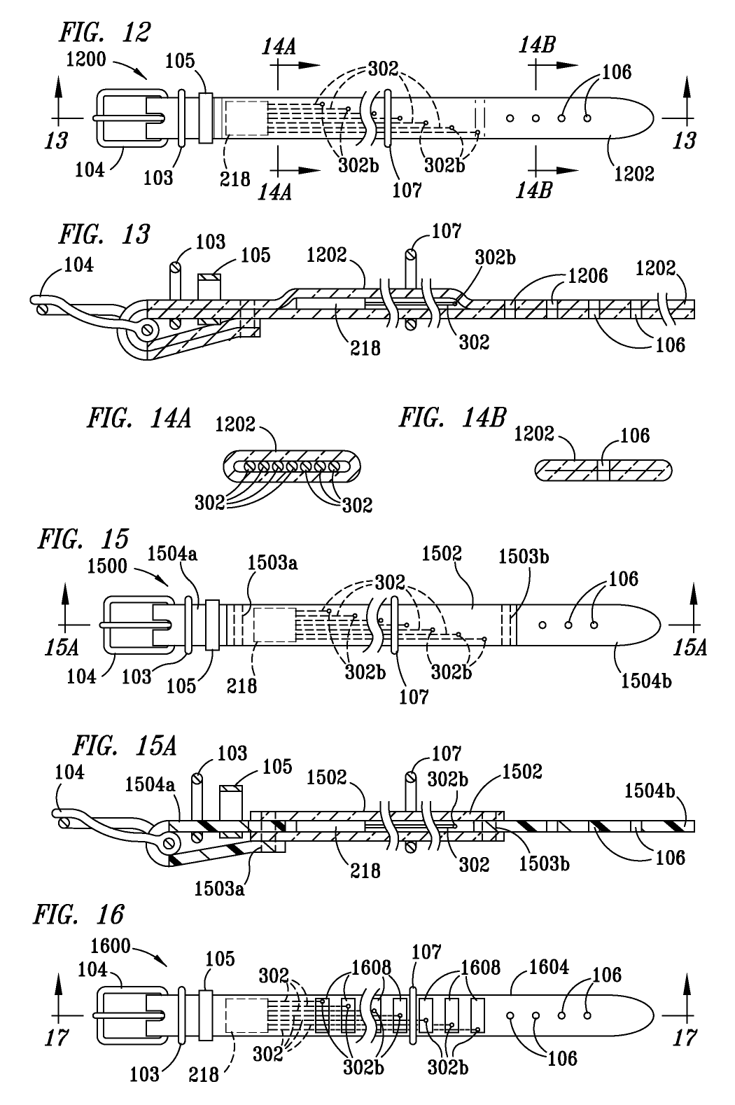

FIGS. 12-15 depict details of a collar 1200 according to an alternate embodiment of the invention. Since the collar 1200 contains many components that are similar to those of the embodiments of FIGS. 1-11, these components are referred to by the same reference numerals and will not be described in any further detail herein, except insofar as necessary to describe the invention.

Referring to the cross-sectional views of FIGS. 14A-14B, the reference numeral 1202 generally refers to a substantially “flattened” tube, corresponding to the collar base 202, although the tube 1202 may alternatively be elliptical or round in cross-section. For the purpose of illustration, the tube 1202 is shown as being continuous about its perimeter, which may be effectuated using conventional tube fabrication techniques or, e.g., by way of thermal sealing of edges, wherein in either case the illumination source 218 and fiber optic strings 302 may be inserted and removed through one or either end of the tube, or the tube 1202 may alternately assume a configuration as described above with respect to any of FIGS. 5-9 or 11C, for facilitating the insertion, removal, and/or replacement of the illumination source 218 or 1118, fiber optic strings 302, and/or power module 1120 through edges of the tube.

The tube 1202 is preferably fabricated without insets, such as the insets 216 (FIGS. 2-4), and is preferably fabricated from a substantially durable and pliable, material, such as plastic, acrylic, silicone, polyurethane, organic, synthetic or semi-synthetic polymer or polymerization product, woven fabric, and woven fabric blends, or the like, effective for use as a collar on a pet and through which light may be illuminated. The material from which the tube 1202 is fabricated is preferably clear, but may alternatively be colored, translucent, and/or include reflective particles and/or glitter dust of one or more colors embedded therein to soften, reflect, and/or diffuse the light generated by the illumination features of the collars, in accordance with principles of the invention described herein. In portions of the material from which the tube 1202 is fabricated, such reflective particles and/or glitter dust are preferably distributed more densely, in such a manner as to direct light away from, rather than toward, the eyes of a pet. Portions of the tube 1202 through which light is not intended to pass (e.g., the portion of the tube facing toward a pet) may be provided with a film of reflective material to reflect light back through portions of the tube 1202 through which light is intended to pass, thereby providing a more efficient utilization of the light generated, and/or requiring less light to be generated and conserving power. The tube 1202 may optionally be further reinforced with wires or cords which extend from the buckle 104 through the length of the collar 1200, e.g., from the buckle along the outer edges of the collar to and around the holes 106.

The fiber optic strings 302 are positioned inside the tube 1202, and are coupled to the illumination source 218, in a manner similar to that described above with respect to FIGS. 1-11; however, the ends 302b of the fiber optic strings are not coupled to the insets 216, but rather are effective for illumination directly through the clear tube 1202. The collar 1200 is exemplified having an illumination source 218 as described above with respect to FIGS. 1-11, but may alternatively comprise an illumination source 1118 and module 1120 as described above with respect to FIGS. 11A-11C. Operation of the collar 1200 is substantially similar to the operation of the embodiments of the collars depicted by FIGS. 1-11C, the only material difference being that the ends 302b of the fiber optic strings illumine directly through the tubing 1202 rather than through descending insets.

FIG. 15 exemplifies a collar 1500 as an alternate embodiment of the collar 1200, the only material difference being that the tube 1202 is replaced by a tube 1502 which extends only insofar as necessary to facilitate the illumination of the ends 302b through the collar 1500. As shown more clearly in FIG. 15A, a first collar portion 1504a is secured, e.g., by way of stitching (e.g., stitching 1503a), adhesive, staples, rivets, snaps, and/or the like, to one end of the tube 1502 for attachment of the buckle 104, tag ring 103, and collar buckle strap 105. A second collar portion 1504b is secured, e.g., by way of stitching (e.g., stitching 1503b), adhesive, staples, rivets, and/or the like, to the other end of the tube 1502 to provide for holes 106 configured for engagement with the buckle 104. The first and second collar portions 1504a and 1504b are preferably fabricated from a durable material such as nylon, leather, or the like. Operation of the collar 1500 is substantially similar to the operation of the embodiments of the collars depicted by FIGS. 1-14B.

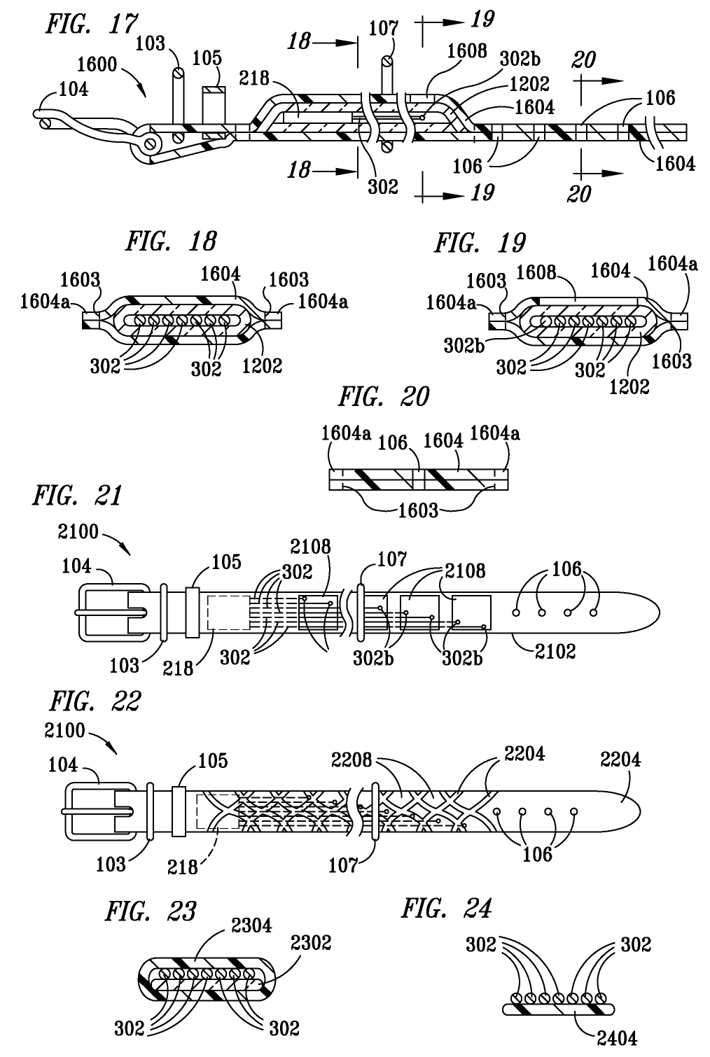

FIGS. 16-20 depict details of a collar 1600 according to an alternate embodiment of the invention. Since the collar 1600 contains many components that are similar to those of the embodiments of FIGS. 1-15, particularly FIGS. 12-15, these components are referred to by the same reference numerals and will not be described in any further detail herein, except insofar as necessary to describe the invention. In contrast to the embodiment of FIGS. 12-15, and as most clearly depicted by FIG. 17, the reference numeral 1604 refers in general to an outer sheath configured for closely fitting about and enveloping the tube 1202. The sheath 1604 is preferably fabricated from a durable material such as nylon, leather, or the like, effective for protecting the tube 1202. As shown in FIGS. 16, 17, and 19, the sheath 1604 further preferably defines at least one opening 1608 for each end 302b of the optical fibers 302, through which a respective end 302b may illumine through the clear tubing 1202. With particular respect to FIG. 19, one end 302a is depicted which illumines through an opening 1608. As shown most clearly in FIGS. 18-20, the sheath 1604 preferably comprises two portions (upper and lower portions as shown) secured together at edges 1604a by way of stitching (e.g., stitching 1603), adhesive, staples, rivets, snaps, and/or the like. Alternatively, the sheath 1604 may comprise a single portion which wraps around the tube 1202 and is secured together along one edge 1604a. While the collar 1600 is exemplified having an illumination source 218, as described above with respect to FIGS. 1-11, it may alternatively comprise an illumination source 1118 and module 1120 as described above with respect to FIGS. 11A-11C. Operation of the collar 1600 is substantially similar to the operation of the embodiments of the collars depicted by FIGS. 12-15.

FIG. 21 depicts details of a collar 2100 according to an alternate embodiment of the invention. Since the collar 2100 contains many components that are similar to those of the embodiment of FIGS. 1-15, and particularly FIGS. 16-20, these components are referred to by the same reference numerals and will not be described in any further detail herein, except insofar as necessary to describe the invention. In contrast to the embodiment of FIGS. 16-20, the openings 2108 are substantially wider than the openings 1608 (FIG. 16), so that multiple ends 302b of the fiber optic strings 302 may illumine through respective openings. While the collar 2100 is exemplified having an illumination source 218, as described above with respect to FIGS. 1-11, it may alternatively comprise an illumination source 1118 and module 1120 as described above with respect to FIGS. 11A-11C. Operation of the collar 2100 is substantially similar to the operation of the embodiments of the collars depicted by FIGS. 16-20.

FIG. 22 depicts details of a collar 2200 according to an alternate embodiment of the invention. Since the collar 2100 contains many components that are similar to those of the embodiment of FIGS. 1-15, and particularly of the embodiments of FIGS. 16-21, these components are referred to by the same reference numerals and will not be described in any further detail herein, except insofar as necessary to describe the invention. In contrast to the embodiments of FIGS. 16-21, the outer sheath 2204 is configured as lacing or braiding with openings 2208 defined between strands of lacing sufficiently large to allow for the illumination of the ends 302b of each optical fiber 302 to pass therethrough. While the sheath 2204 is depicted as a braided or laced pattern, it is understood that the sheath may be configured in any of a number of different patterns as desired, or even a braiding or lacing of the tube 1202 through the sheath or collar, provided there are openings to facilitate illumination of the ends 302a through the collar. While the collar 2200 is exemplified having an illumination source 218, as described above with respect to FIGS. 1-11, it may alternatively comprise an illumination source 1118 and module 1120 as described above with respect to FIGS. 11A-11C. Operation of the collar 2200 is substantially similar to the operation of the embodiments of the collars depicted by FIGS. 16-21.

It is understood that the present invention may take many forms and embodiments. Accordingly, several variations may be made in the foregoing without departing from the spirit or the scope of the invention. For example, by way of a cross-section depicted in FIG. 23, fiber optic strings 302 are positioned on a substrate 2302 fabricated from a material such as the material constituting the tube 1202, and the substrate 2302 and optical fibers 302 are encased in a sheath 2304, such as the sheath 1604, described above with respect to FIGS. 16-20. In another example, depicted by way of a cross-section in FIG. 24, fiber optic strings 302 are positioned on a substrate 2404 fabricated from a material such as the material constituting the sheath 1604 (e.g., nylon, leather), described above with respect to FIGS. 16-20. While not shown, the optical fibers 302 are preferably secured onto the substrate 2404 by way of adhesive, such as epoxy, or polyurethane, or the like. It is understood that the cross-sections depicted by FIGS. 23 and 24 may be incorporated into the embodiments of any of FIGS. 12-32.

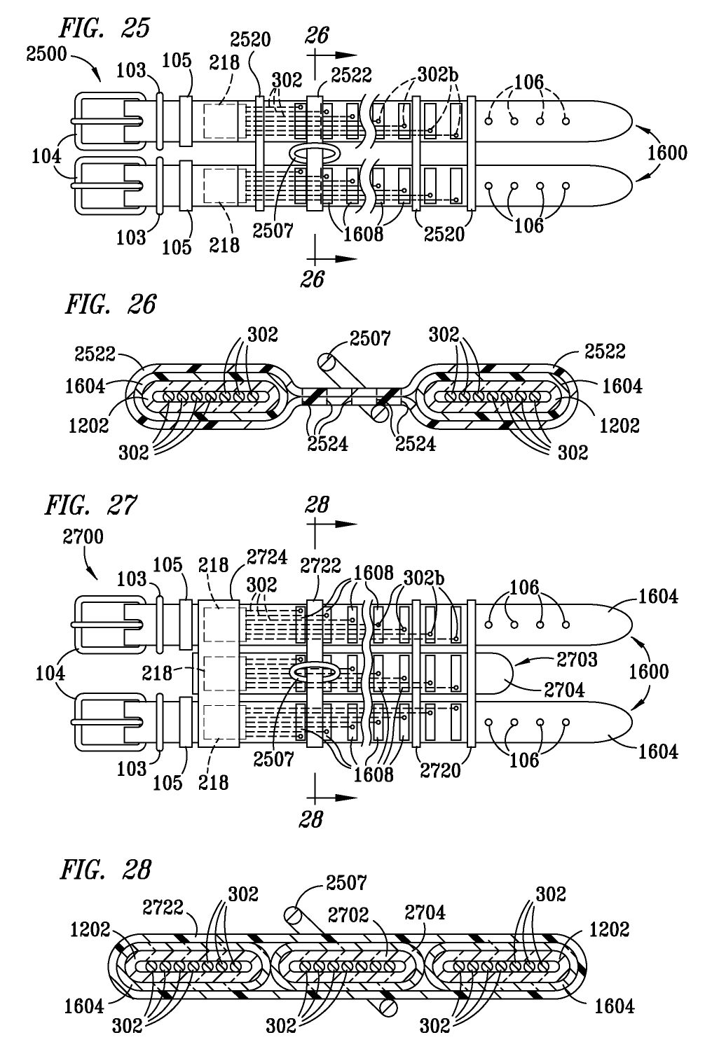

In examples of further variations, or alternative embodiments, of the present invention, two or more of the foregoing collars may be coupled together in various configurations for fitting on larger pets. By way of example, in FIG. 25, and in the corresponding cross-section depicted by FIG. 26, two collars, such as the collars 1600, described above with respect to FIGS. 16-20, are coupled together preferably by way of at least one wide band 2522, and one or more narrow bands 2520. The bands 2520 and 2522 are preferably fabricated from a durable material such as nylon, heavy cloth, leather, or the like, and are wrapped around or otherwise secured to each of the collars 1600 by way of stitching (e.g., stitching 3024), adhesive, staples, rivets, snaps, and/or the like. The wide band 2522 is preferably threaded through a leash ring 2507 to which ring a leash (not shown) may be attached for walking or otherwise restraining a pet wearing the collar. While the collar 2500 is depicted as a coupling of two collars 1600, other collars, such as the collar 100, 1200, 1500, 2100, 2200, or the like, may be so coupled, as described further below, and more than two (e.g., three or four) such collars may be so coupled. Operation of the collar 2500 is similar to the operation of the collar 1600 of FIGS. 16-21, the only material difference being that there are two clasps to secure, and there are two power supplies to maintain.

Further to the collar 2500, in FIG. 27, and corresponding cross-section depicted by FIG. 28, the collars 1600 are spaced apart and an intermediate collar portion 2703 is interposed therebetween. But for lacking a clasp 104 and mating holes 106 for buckling the collar, the collar 2703 is exemplified as being similar to the collar 1600, though it may alternatively be configured similarly to the collar 1200, 2100, 2200, or the like. One or more narrow bands 2720, wide bands 2722, and extra wide bands 2724, similar to the bands 2520 and 2522, are preferably wrapped around or otherwise secured to the collars 1600 and 2903 by way of adhesive, rivets, staples, stitching, snaps, and/or the like. The leash ring 2507 is preferably attached to the wide band 2722 as described above with respect to FIGS. 25 and 26. Operation of the collar 2700 is similar to the operation of the collar 2500 of FIGS. 25-26.

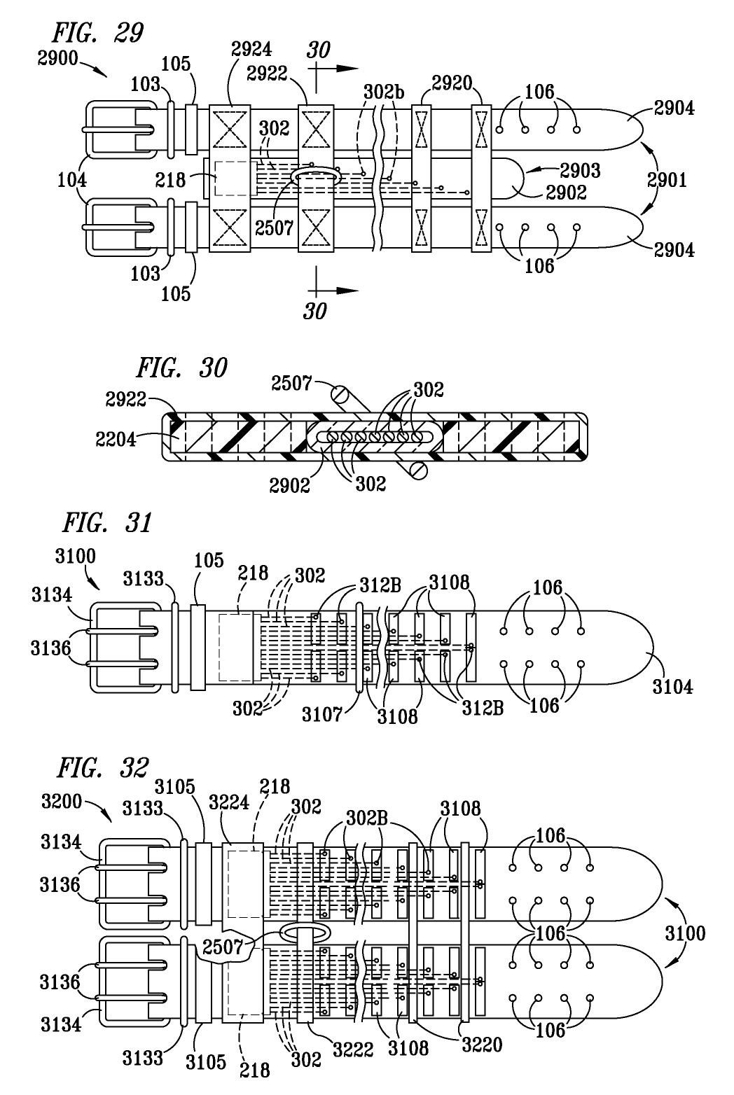

FIG. 29, and the corresponding cross-section shown by FIG. 30, depict a collar 2900, which exemplifies a variation to the collar 2700, wherein the two collars 1600 are replaced by two conventional collars 2901, i. e., collars lacking illumination features. An intermediate collar portion 2903 is interposed between the two collars 2901, the intermediate collar portion 2903 being similar to the intermediate collar portion 2703, having a clear tube 2902 similar to the tube 1202 of collar 1200, but lacking the outer sheath 1604 of the collar portion 2703. One or more narrow bands 2920, wide bands 2922, and extra wide bands 2924, similar to the bands 2520 and 2522, are preferably wrapped around or otherwise secured to the collars 2901 and 2903 by way of adhesive, staples, rivets, stitching, snaps, and/or the like. A leash ring 2507 is preferably attached to a wide band 2522 as described above with respect to FIGS. 25 and 26. Operation of the collar 2900 is similar to the operation of the collar 2700 of FIGS. 27-28, but for the collars 2901 lacking illumination.

FIG. 31 exemplifies a further variation of a safety collar that may be implemented in accordance with the present invention. Accordingly, a collar 3100 similar, for example, to the collar 1600, is fabricated sufficiently wide to permit a clasp, such as the buckle 3134, having dual catches 3136 and corresponding dual holes 106 for facilitating buckling of the collar 3100. The openings 1608 of the collar 1600 are reconfigured for the collar 3100 as dual openings 3108. It is understood that the collar 3100 may be made sufficiently wide to accommodate larger buckles having more than two catches. The collar 3100 is preferably also provided with a leash ring 3107. Operation of the collar 3100 is similar to the operation of the collar 1600 of FIGS. 16-20, but for engagement of the dual catches 3136 of the clasp 3134 with the holes 106.

In an embodiment of the invention exemplified by FIG. 32, a collar 3200 comprises multiple collars, exemplified as two collars 3100, described above with respect to FIG. 31. The collars 3100 are coupled by way of bands 3220, 3222, and 3224, similar to the bands 2720, 2722, and 2724. Operation of the collar 3200 is similar to the operation of the collar 3100 of FIG. 31, but for the buckling of two clasps 3134, instead of one.

By the use of the present invention, an improved collar is provided which does not constitute a burden and is comfortable to a pet wearing the collar, while providing at the same time a clear, visible warning effective for enabling a person to identify the location of a pet, and thereby to assist in avoiding unwanted contact with such a pet in an unlighted environment, which unwanted contact could result in injury to the person and/or the pet.

It is understood that the present invention may take many forms and embodiments. Accordingly, several variations may be made in the foregoing without departing from the spirit or the scope of the invention. For example, the invention may be utilized or implemented in connection with specific animal applications or as a component of a medical apparatus, e.g., as a brace, splint, or cast. Alternatively, the principles of the invention may be implemented in a harness or leash, or a harness or leash proximate to the collar may be provided with at least one access point to a collar to receive light or electrical current to enable lights (e.g., LED's) on the harness or leash to be illuminated along with lights on the collar. In another embodiment, the illumination source 218 may be positioned on the interior surface of the collar base 202, or within an opening cut out of the collar base 202. One or more colors of light may be emitted from each inset 216 (FIGS. 1-10) or each second end of 302b of each fiber optic string 302 (FIGS. 12-32). Light-generating elements (e.g., LED's) may be selected that emit light of colors (i.e., frequencies) that do not attract, or that even repel, pests, such as ticks, insects, fleas, mosquitoes, and the like. Pesticide substances may also be provided with the collar, e.g., on an underside of the collar, to further repel pests, such as ticks, insects, fleas, mosquitoes, and the like. In another embodiment of the invention, a transmitter may be configured to activate an alarm to alert a person when a pet has entered a room or crossed a portal, such as when entering or leaving a house. Certain embodiments may also include automatic activation of the lights by a light and/or motion sensing means on the collar, so that the illumination source 218 is activated when ambient light is less than a predetermined threshold amount of light and/or motion exceeds a predetermined threshold. A microprocessor may be coupled to the power supply and light generating elements for controlling the power supply and light generating elements.

Other embodiments of the invention may be provided with multiple power supplies and/or illumination sources; for example, a collar may be provided with a power supply and illumination source at each of two ends of a collar, with respective fiber optic strings extending from each respective illumination source. In still further embodiments of, e.g., FIGS. 16-22 and 25-32, multiple tubes (e.g., the tube 1202), each having one or more power supplies, illumination sources, and respective fiber optic strings, may be enveloped within a single sheath (e.g., the sheath 1604). In multiple collar designs, such as described above with respect to FIGS. 25-32, one or more collars of the multiple collars may be configured utilizing insets to illumine light, as described above with respect to FIGS. 1-11C. If heat generated from the one or more power supplies and/or illumination sources would be bothersome to a pet, then holes may be defined in the collar to permit such heat to dissipate.

In a still further embodiment, the illumination source 218 may generate light in an intermittent manner (e.g., repeatedly blinking on and off, wherein the periods of being on and off may or may not be equal) to thereby be more readily perceived and also conserve electrical power, and individual fiber optic strings 302 may operate intermittently in a synchronous or asynchronous manner. Multiple light-generating elements 1006 may be connected to one or more insets (e.g., FIGS. 1-11) and/or second ends of 302b of fiber optic strings 302 (e.g., FIGS. 12-32) for displaying light, wherein each light-generating element 1006 may generate light of different color and/or intermittently and, if intermittently, then the light-generating elements 1006 may or may not be synchronized with each other.

One or more of the light generating elements, such as LED's, of one or more colors, may be positioned within each inset (FIGS. 1-11) or at selected points along a collar (FIGS. 12-32) and be electrically coupled to a power supply similar to that used in connection with the illumination source 218, but without the light-generating element 1006 positioned proximate to the power supply and without the fiber optic strings 302, the light generating elements being adapted to generate light continuously or intermittently, and, if intermittently, either in or out of synchronization with each other, and wherein the power supply and/or illumination of light generating elements may optionally be controlled by a microprocessor positioned on the collar. Accordingly, a collar may be provided with a power supply, and one or more of the light generating elements electrically coupled to the power supply and positioned for illumination at selected points along the collar. The collar may further comprise insets positioned at the selected points, wherein the light generating elements are adapted for illumination through the insets, and/or it may comprise at least one substantially clear tube, wherein the light generating elements are mounted within the at least one tube. The one or more light generating elements may comprise one or more light emitting diodes (LED's), which LED's may further be adapted for generating light of one or more colors. The one or more light generating elements may further be adapted to generate light intermittently and/or asynchronously with each other.

The present invention may also be adapted for providing illumination on pet jewelry, clothing, tack (e.g., harness, bridles, and/or the like for a horse, dog, and/or the like), accessories, and the like. Illumination of pet collars, clothing, and accessories may, for example, be adapted to help pets assist in law enforcement, emergency, and rescue efforts. Such illumination may reduce the risk that a pet may incur in emergencies by alerting a community of the presence of a working pet, in a manner analogous to that of lighting on an ambulance, which helps the community clear the way for emergency personnel. Illumination of pet collars, clothing, and accessories may also be adapted to help pets in assisting people, for example, in walking or in retrieving items in a home for a person.

Still further, the present invention may be adapted for use on people's jewelry and clothing, such as daily clothing (e.g., dresses, shirts with designs, and the like), halter tops, garments worn during emergencies and rescue operations, and related accessories. By way of example but not limitation, the present invention may be adapted to enhance safety by providing for illumination on fireman overcoats and hats and on pajamas for young children, to thereby enable firemen and children to be more readily located in dimly lit areas. The present invention may be adapted for aesthetic purposes as well, such as designs on pajamas, watch bands, and the like.

Accordingly, a garment may be provided with at least one illumination source mounted on the garment, and one or more light-transferring fibers, each of which fibers comprises a first end and a second end, the first end being coupled to the at least one illumination source for receiving light from the at least one illumination source, and the second end being positioned for transmitting light to one or more selected points proximate to the garment. The garment may further comprise at least one of clothing worn by people, clothing worn by pets, overcoats, hats, pajamas, watch bands, and halters.

Jewelry may be provided with at least one illumination source mounted proximate to the jewelry, and one or more light-transferring fibers, each of which fibers comprises a first end and a second end, the first end being coupled to the at least one illumination source for receiving light from the at least one illumination source, and the second end being positioned for transmitting light to one or more selected points proximate to the jewelry.

Medical apparatus may be provided with at least one illumination source mounted proximate to the medical apparatus, and one or more light-transferring fibers, each of which fibers comprises a first end and a second end, the first end being coupled to the at least one illumination source for receiving light from the at least one illumination source, and the second end being positioned for transmitting light to one or more selected points proximate to the medical apparatus. The medical apparatus may further comprise at least one of a brace splint, splint, and a cast.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A collar comprising:
at least one substantially clear tube;
at least one illumination source mounted within said at least one tube; and
one or more light-transferring fibers, each of which fibers includes a first end and a second end, the first end being coupled for receiving light from said at least one illumination source, and the second end being positioned for transmitting light to one or more selected points located along said at least one tube for illumination therefrom.

2. The collar of claim 1, wherein said tube is fabricated from at least one of plastic, acrylic, silicone, polyurethane, organic, synthetic or semi-synthetic polymer or polymerization product, woven fabric, woven fabric blends, adapted for use as a collar on a pet and through which light may illumine.

3. The collar of claim 1, wherein said tube is fabricated from a colored material so that light illumined therethrough is colored.

4. The collar of claim 1, wherein said tube is fabricated from a translucent material adapted for diffusing light passing therethrough.

5. The collar of claim 1, wherein said tube is fabricated from a substantially clear material having a plurality of reflective particles embedded therein to reflect light.

6. The collar of claim 1, wherein said tube is fabricated from a substantially clear material having a plurality of reflective particles embedded therein to reflect light, said plurality of reflective particles being more concentrated on a side of said collar facing toward the eyes of said pet, to thereby reflect light away from said pet's eyes.

7. The collar of claim 1, further comprising a film of reflective material positioned on said at least one tube to reflect light away from said pet's eyes.

8. The collar of claim 1, wherein said tube is fabricated from a substantially clear material having a plurality of reflective particles of one or more colors embedded therein to reflect light.

9. The collar of claim 1, further comprising a portion fabricated from at least one of leather and nylon coupled to said at least one tube.

10. The collar of claim 1, further comprising a portion fabricated from at least one of leather and nylon, said portion being configured for enveloping at least a portion of said at least one tube.

11. The collar of claim 1, wherein said at least one tube comprises at least two tubes coupled together, said at least one illumination source comprises at least two illumination sources, said one or more light-transferring fibers comprise two or more light-transferring fibers, and each of at least one of said at least two tubes respectively comprises:
at least one of said at least two illumination sources mounted within a respective one of said at least two tubes; and
at least one of said two or more light-transferring fibers, each of which fibers includes a first end and a second end, the first end being coupled for receiving light from a respective one of said at least two illumination sources, and the second end being positioned for transmitting light to one or more selected points located along said respective one of said at least two tubes for illumination therefrom.

12. The collar of claim 1, wherein said at least one tube comprises at least two tubes coupled together, said at least one illumination source comprises at least two illumination sources, said one or more light-transferring fibers comprise two or more light-transferring fibers, and said collar further comprises at least one band for coupling said at least two collars together, and at least one leash ring coupled to said at least one band, and each of at least one of said at least two tubes respectively comprises:
at least one of said at least two illumination sources mounted within a respective one of said at least two tubes; and
at least one of said two or more light-transferring fibers, each of which fibers includes a first end and a second end, the first end being coupled for receiving light from a respective one of said at least two illumination sources, and the second end being positioned for transmitting light to one or more selected points located along said respective one of said at least two tubes for illumination therefrom.

13. The collar of claim 1, wherein said at least one tube comprises at least two tubes coupled together, said at least one illumination source comprises at least two illumination sources, said one or more light-transferring fibers comprise two or more light-transferring fibers, and each of at least one of said at least two tubes respectively comprises:
at least one of said at least two illumination sources mounted within a respective one of said at least two tubes;
at least one of said two or more light-transferring fibers, each of which fibers includes a first end and a second end, the first end being coupled for receiving light from a respective one of said at least two illumination sources, and the second end being positioned for transmitting light to one or more selected points located along said respective one of said at least two tubes for illumination therefrom; and
a portion fabricated from at least one of leather and nylon coupled to said respective one of said at least two tubes.

14. The collar of claim 1, wherein said at least one tube comprises at least two tubes coupled together, said at least one illumination source comprises at least two illumination sources, said one or more light-transferring fibers comprise two or more light-transferring fibers, and each of at least one of said at least two tubes respectively comprises:
at least one of said at least two illumination sources mounted within a respective one of said at least two tubes;
at least one of said two or more light-transferring fibers, each of which fibers includes a first end and a second end, the first end being coupled for receiving light from a respective one of said at least two illumination sources, and the second end being positioned for transmitting light to one or more selected points located along said respective one of said at least two tubes for illumination therefrom; and
a portion fabricated from at least one of leather and nylon, said portion being configured for enveloping at least a portion of said respective one of said at least two tubes.

15. The collar of claim 1, further comprising at least one electrical power supply detachably coupled to said at least one illumination source for supplying power to said at least one illumination source.

16. The collar of claim 1, wherein said at least one illumination source is adapted for generating light intermittently.

17. The collar of claim 1, wherein said at least one illumination source comprises one or more light generating elements, at least one power supply connected to said one or more light generating elements for supplying power to said one or more light generating elements, and a control mechanism connected to said at least one power supply and operable for controlling the supply of power provided by said at least one power supply to said one or more light generating elements.

18. The collar of claim 1, wherein said at least one illumination source comprises one or more light generating elements, at least one power supply connected to said one or more light generating elements for supplying power to said one or more light generating elements, and a control mechanism connected to said at least one power supply and operable for controlling the supply of power provided by said at least one power supply to said one or more light generating elements, said one or more light generating elements comprising at least one of one or more LED's and one or more light bulbs.

19. The collar of claim 1, wherein said at least one illumination source comprises one or more light generating elements, a battery connected to said one or more light generating elements for supplying power to said one or more light generating elements, and a control mechanism connected to said battery and operable for controlling the supply of power provided by said battery to said one or more light generating elements.

20. The collar of claim 1, wherein said one or more selected points are located on said collar so that, when said collar is mounted on a pet, light from the second end of said one or more light-transferring fibers is directed substantially away from the face and eyes of said pet.

21. The collar of claim 1, wherein said one or more light-transferring fibers comprise one or more fiber optic filaments.

22. The collar of claim 1, further comprising sensing means for activating said at least one illumination source when ambient light is less than a predetermined threshold amount of light.

23. The collar of claim 1, further comprising sensing means for activating said at least one illumination source when motion exceeds a predetermined threshold.

24. The collar of claim 1, further comprising a transmitter adapted to activate an alarm when a pet wearing said collar enters a room.

25. The collar of claim 1, further comprising a transmitter adapted to activate an alarm when a pet wearing said collar crosses a portal.

26. The collar of claim 1, further comprising a leash coupled to said collar, said leash having one or more light-transferring fibers coupled to said at least one illumination source for facilitating illumination along said leash.

27. The collar of claim 1, further comprising a harness coupled to said collar, said harness having one or more light-transferring fibers coupled to said at least one illumination source for facilitating illumination along said harness.

28. The collar of claim 1, further comprising an a Radio Frequency Identification (RFID) transponder adapted for responding via a radio communication link to an RFID transceiver.

29. The collar of claim 1, further comprising a global positioning system (GPS) device and a transmitter adapted for transmitting, via a radio communication link, a signal indicative of a pet's location to a receiver.

30. The collar of claim 1, further comprising a electronic pet containment device adapted for controlling where a pet travels.

31. A collar comprising:
a power supply; and
one or more of light generating elements electrically coupled to said power supply and positioned for illumination at selected points along said collar.
